(19) United States
(12) Patent Application Publication
(10) Pub. No.: US 2016/0248628 A1
(43) Pub. Date: Aug. 25, 2016

(54) QUEUE PAIR STATE TRANSITION SPEEDUP

(71) Applicant: Avago Technologies General IP (Singapore) Pte. Ltd., Singapore (SG)

(72) Inventors: Parav K. Pandit, Bangalore (IN); Aravinda Venkatramana, Austin, TX (US); Aniketa Sreedhar, Fremont, CA (US); Devesh Sharma, Bangalore (IN); Masoodur Rahman, Austin, TX (US)

(21) Appl. No.: 15/019,964

(22) Filed: Feb. 9, 2016

Related U.S. Application Data
(60) Provisional application No. 62/114,191, filed on Feb. 10, 2015.

(51) Int. Cl. H04L 12/24; G06F 15/167; H04L 29/08

(52) U.S. Cl. CPC H04L 41/0806; H04L 67/1097; G06F 15/167

(57) ABSTRACT

A computing or controlling apparatus includes a remote direct memory access (RDMA) adapter device. Responsive to an initialized state, a create queue pair adapter device command is provided by a host processing unit. The adapter device processes the command to create a queue pair in the initialized state. Responsive to a ready to send (RTS) state, a queue pair state transition command is provided by the host processing unit. The adapter device processes the queue pair state transition command to transition the queue pair from the initialized state to the ready to send (RTS) state skipping over the ready to receive (RTR) state. However, if the adapter device processes a ready to receive (RTR) in-band RDMA WQE received from the host processing unit, the state of the queue pair transitions from the initialized state to the RTR state. The adapter device then processes a ready to send (RTS) in-band RDMA WQE received from the host processing unit via the queue pair to transition the queue pair from the RTR state to the RTS state.

### CROSS-REFERENCE TO RELATED APPLICATIONS

“This non-provisional United States (U.S.) patent application claims the benefit of U.S. Provisional Patent Application No. 62/114,191 entitled QUEUE PAIR STATE TRANSITION SPEEDUP filed on Feb. 10, 2015 by inventors Pandit et al.

### FIELD

The embodiments relate generally to remote direct memory access (RDMA) queue pair (QP) state transitions.

### BACKGROUND

Before an RDMA queue pair (QP) is usable in a network adapter, the QP passes through various states beginning with a reset state. Due to the various operations involved to establish and make the QP operable in the network adapter from the reset state, considerable establishment time is taken.

Traditionally RDMA QP creation, state transition, and destruction or tear down is achieved using a network adapter's control path firmware.

It is desirable to decrease the time taken to establish RDMA connections with a network adapter.

### BRIEF SUMMARY

Embodiments disclosed herein are summarized by the claims that follow below. However, this brief summary is being provided so that the nature of this disclosure may be understood quickly.

It is desirable to reduce the establishment time to make a remote direct memory access (RDMA) queue pair (QP) usable. It is desirable to reduce the number of host commands needed to make the QP usable.

These needs are addressed by an RDMA adapter device that creates a queue pair in an initialized state instead of reset state, and an RDMA adapter device that transitions a state of the queue pair responsive to an in-band RDMA Work Queue Element (WQE) received via the queue pair.

In an embodiment, an RDMA adapter device creates a queue pair in an initialized state, responsive to an initialized state create queue pair adapter device command provided by a host processing unit.

In an embodiment, an RDMA adapter device creates a queue pair in an initialized state, responsive to an initialized state create queue pair adapter device command provided by a host processing unit. The adapter device transitions the queue pair from the initialized state to a ready to send (RTS) state responsive to an RTS state queue pair state transition command provided by the host processing unit. The RTS state queue pair state transition adapter device command provides RDMA transmit operation information and RDMA receive operation information for the RDMA queue pair from the host processing unit to the adapter device.

In an embodiment, an RDMA adapter device creates a queue pair in an initialized state, responsive to an initialized state create queue pair adapter device command provided by a host processing unit. The adapter device transitions the queue pair from the initialized state to a ready to send (RTS) state responsive to a ready to send (RTS) in-band RDMA WQE received from the host processing unit via the queue pair. The RTS in-band RDMA WQE includes RDMA receive operation information and RDMA transmit operation information to configure the created queue pair for RDMA receive and transmit operations and to transition the RDMA queue pair from the initialized state to the ready to send state.

In an embodiment, an RDMA adapter device creates a queue pair in an initialized state, responsive to an initialized state create queue pair adapter device command provided by a host processing unit. The adapter device transitions the queue pair from the initialized state to a ready to receive (RTR) state responsive to a ready to receive (RTR) in-band RDMA WQE received from the host processing unit via the queue pair. The RTR in-band RDMA WQE includes RDMA receive operation information to configure the created queue pair for RDMA receive operations and to transition the RDMA queue pair from the initialized state to the ready to receive state. The adapter device transitions the queue pair from the RTR state to a ready to send (RTS) state responsive to a ready to send (RTS) in-band RDMA WQE received from the host processing unit via the queue pair. The RTS in-band RDMA WQE includes RDMA transmit operation information to configure the created queue pair for RDMA transmit operations and to transition the RDMA queue pair from the RTR state to the RTS state.

In an embodiment, an RDMA adapter device creates a queue pair in a RESET state, responsive to a RESET state create queue pair adapter device command provided by a host processing unit. The adapter device transitions the queue pair from the RESET state to an initialized state responsive to an initialized state queue pair state transition command provided by the host processing unit. The adapter device transitions the queue pair from the initialized state to a ready to receive (RTR) state responsive to a ready to receive (RTR) in-band RDMA WQE received from the host processing unit via the queue pair. The RTR in-band RDMA WQE includes RDMA receive operation information to configure the created queue pair for RDMA receive operations and to transition the RDMA queue pair from the initialized state to the ready to receive state. The adapter device transitions the queue pair from the RTR state to a ready to send (RTS) state responsive to a ready to send (RTS) in-band RDMA WQE received from the host processing unit via the queue pair. The RTS in-band RDMA WQE includes RDMA transmit operation information to configure the created queue pair for RDMA transmit operations and to transition the RDMA queue pair from the RTR state to the ready to send state.

According to an aspect, responsive to reception of at least one of an ERROR queue pair state transition adapter device command and an ERROR state transition in-band RDMA WQE provided by the host processing unit and received by the adapter device, the adapter device transitions the RDMA queue pair to an ERROR state.

According to an aspect, responsive to reception of at least one of a recycle queue pair state transition adapter device command and a recycle state transition in-band RDMA WQE a provided by the host processing unit and received by the adapter device, the adapter device transitions the RDMA queue pair from the ERROR state to either the INIT state or a RESET state.

### BRIEF DESCRIPTIONS OF THE DRAWINGS

FIG. 1 is a state transition diagram that depicts queue pair (QP) state transition in relation to QP creation that involves sending four control path commands to an adapter device to make a QP usable for RDMA send/write/read operations.

FIG. 2A is a block diagram depicting an exemplary computer networking system with a data center network system having a remote direct memory access (RDMA) communication network, according to an example embodiment.

FIG. 2B is a diagram depicting an exemplary RDMA system, according to an example embodiment.

FIG. 3 is an architecture diagram of an RDMA system, according to an example embodiment.

FIG. 4 is an architecture diagram of an RDMA network adapter device, according to an example embodiment.

FIG. 5 is a state transition diagram, according to an example embodiment.

FIG. 6 is a state transition diagram, according to an example embodiment.

FIG. 7 is a state transition diagram, according to an example embodiment.

FIG. 8 is a state transition diagram, according to an example embodiment.

### DETAILED DESCRIPTION

In the following detailed description of the embodiments, numerous specific details are set forth in order to provide a thorough understanding. However, it will be obvious to one skilled in the art that the embodiments may be practiced without these specific details. In other instances well known methods, procedures, components, and circuits have not been described in detail so as not to unnecessarily obscure aspects of the embodiments.

The embodiments include methods, apparatuses and systems for providing remote direct memory access (RDMA).

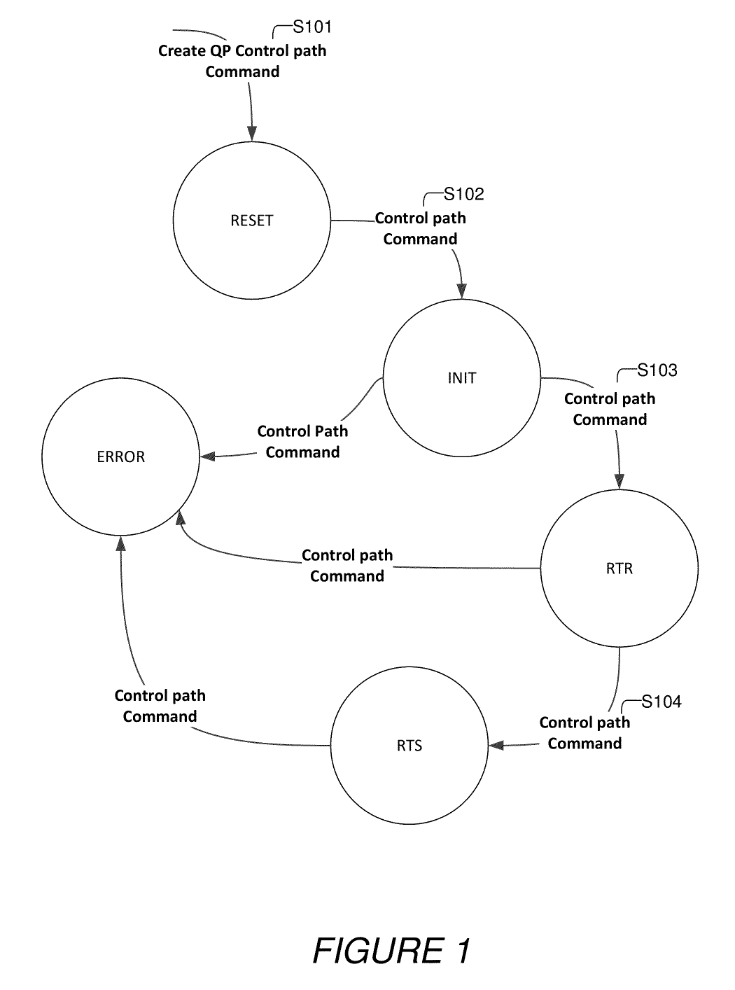

FIG. 1 is a state transition diagram that depicts queue pair (QP) state transition in relation to QP creation that involves sending four control path commands to an adapter device to make a QP (queue pair) in a usable state for data send and receive operations. As shown in FIG. 1, to bring an RDMA queue pair (QP) of a network adapter to a usable state, the QP is created in a reset (RESET) state using a control path command that is invoked by host software. Firmware of the network adapter allocates internal resources and assigns a QP ID. The host software then issues follow on control path commands to transition the QP to an initialization (INIT) state, followed by a ready to read (RTR) state, and optionally a ready to send (RTS) state. Thus, bringing up a queue pair to be able to read and send data may involve invocation of four adapter device control path commands by the host software.

Referring to FIG. 1, at process S101, host software sends a Create QP control path command to the adapter device. The adapter device creates a QP in the RESET state in response to the Create QP control path command. The adapter device allocates internal resources and assigns a QP ID to the queue pair. At process S102, the host software sends a state transition control path command to the adapter device to transition the QP from the RESET state to an Initialized (INIT) state. At process S103, the host software sends a state transition control path command to the adapter device to transition the QP from the INIT state to a ready to receive (RTR) state. At process S104, the host software sends a state transition control path command to the adapter device to transition the QP from the RTR state to a ready to send (RTS) state.

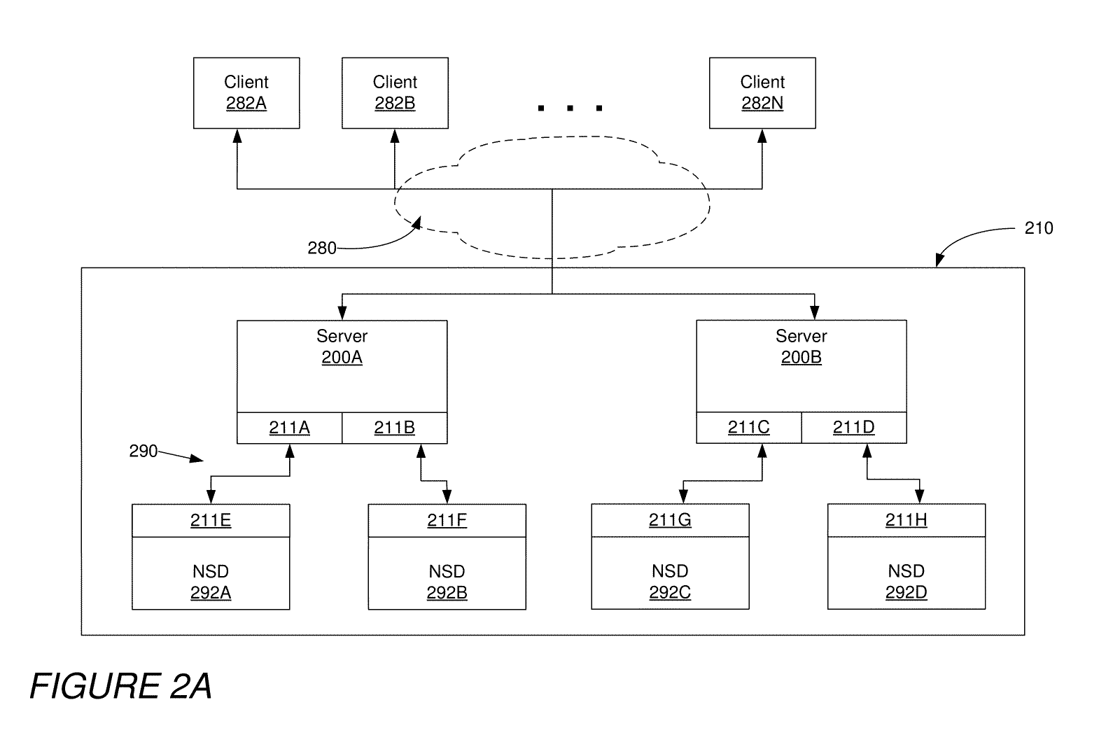

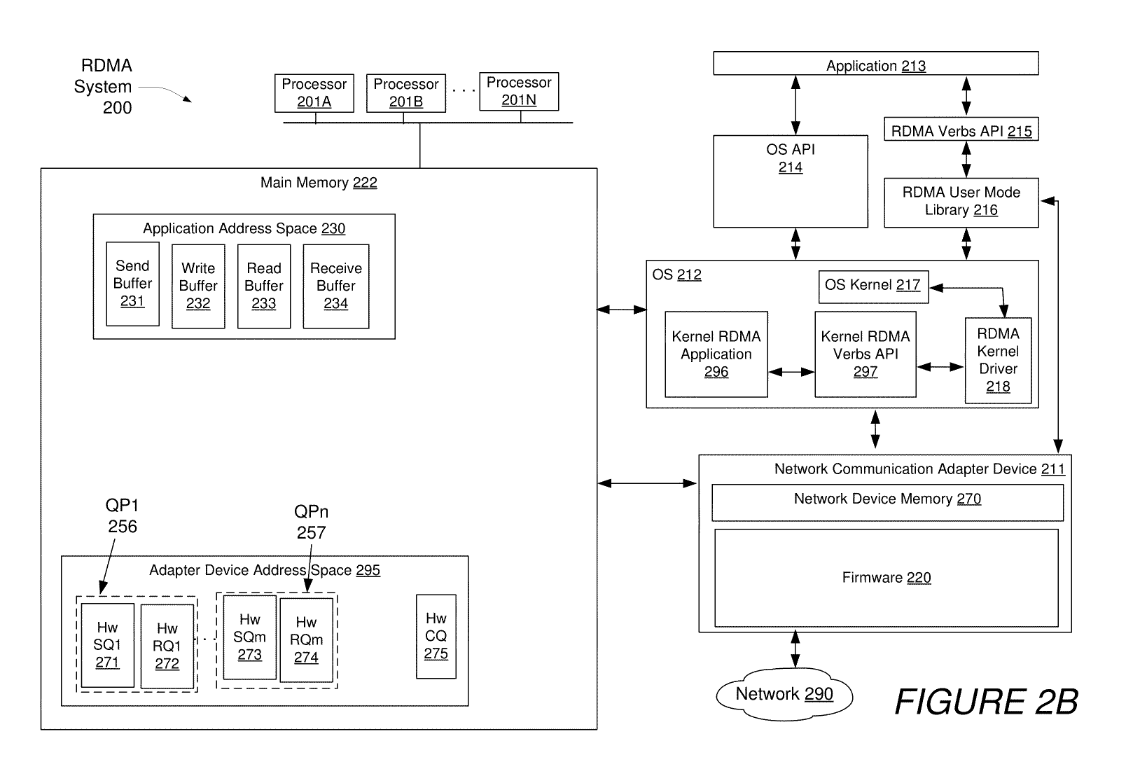

Referring now to FIG. 2A, a block diagram illustrates an exemplary computer networking system with a data center network system 210 having an RDMA communication network 290 in accordance with an example embodiment. One or more remote client computers 282A-282N may be coupled in communication with the one or more servers 200A-200B of the data center network system 210 by a wide area network (WAN) 280, such as the world wide web (WWW) or internet.

The data center network system 210 includes one or more server devices 200A-200B and one or more network storage devices (NSD) 292A-292D coupled in communication together by the RDMA communication network 290. RDMA message packets are communicated over wires or cables of the RDMA communication network 290 the one or more server devices 200A-200B and the one or more network storage devices (NSD) 292A-292D. To support the communication of RDMA message packets, the one or more servers 200A-200B may each include one or more RDMA network interface controllers (RNICs) 211A-211B,211C-211D (sometimes referred to as RDMA host channel adapters), also referred to herein as network communication adapter device(s) 211.

To support the communication of RDMA message packets, each of the one or more network storage devices (NSD) 292A-292D includes at least one RDMA network interface controller (RNIC) 211E-211H, respectively. Each of the one or more network storage devices (NSD) 292A-292D includes a storage capacity of one or more storage devices (e.g., hard disk drive, solid state drive, optical drive) that can store data. The data stored in the storage devices of each of the one or more network storage devices (NSD) 292A-292D may be accessed by RDMA aware software applications, such as a database application. A client computer may optionally include an RDMA network interface controller (not shown in FIG. 2A) and execute RDMA aware software applications to communicate RDMA message packets with the network storage devices 292A-292D.

Referring now to FIG. 2B, a block diagram illustrates an exemplary RDMA system 200 that can be instantiated as the server devices 200A-200B of the data center network 210, in accordance with an example embodiment. In the example embodiment, the RDMA system 200 is a server device. In some embodiments, the RDMA system 200 can be any other suitable type of RDMA system, such as, for example, a client device, a network device, a storage device, a mobile device, a smart appliance, a wearable device, a medical device, a sensor device, a vehicle, and the like.

The RDMA system 200 is an exemplary RDMA-enabled information processing apparatus that is configured for RDMA communication to transmit and/or receive RDMA message packets. The RDMA system 200 includes a plurality of processors 201A-201N, a network communication adapter device 211, and a main memory 222 coupled together. One of the processors 201A-201N is designated a master processor to execute instructions of an operating system (OS) 212, an application 213, an Operating System API 214, a user RDMA Verbs API 215, and an RDMA user-mode library 216 (a user-mode module). The OS 212 includes software instructions of an OS kernel 217, an RDMA kernel driver 218, a Kernel RDMA application 296, and a Kernel RDMA Verbs API 297.

The main memory 222 includes an application address space 230, and an adapter device address space 295. The application address space 230 is accessible by user-space processes. The adapter device address space 295 is accessible by user-space and kernel-space processes and the adapter device firmware module 220.

The application address space 230 includes buffers 231 to 234 used by the application 213 for RDMA transactions. The buffers include a send buffer 231, a write buffer 232, a read buffer 233 and a receive buffer 234.

As shown in FIG. 2B, the RDMA system 200 includes two queue pairs, the queue pair (QP) 256 and the queue pair (QP) 257.

The queue pair 256 includes an adapter device send queue 271, and an adapter device receive queue 272. In the example implementation, the adapter device RDMA completion queue (CP) 275 is used in connection with the adapter device send queue 271 and the adapter device receive queue 272.

Similarly, the queue pair 257 includes an adapter device send queue 273 and an adapter device receive queue 274.

In the example implementation, the application 213 creates the queue pairs 256 and 257 by using the RDMA verbs application programming interface (API) 215 and the RDMA user mode library 216. During creation of the queue pair 256, the RDMA user mode library 216 creates the adapter device send queue 271 and the adapter device receive queue 272 in the adapter device address space 295.

In the example implementation, the RDMA verbs API 215, the RDMA user-mode library 216, the RDMA kernel driver 218, the Kernel RDMA verbs API 297 and the network device firmware module 220 provide RDMA functionality in accordance with the INIFNIBAND Architecture (IBA) specification (e.g., INIFNIBAND Architecture Specification Volume 1, Release 1.2.1 and Supplement to INIFNIBAND Architecture Specification Volume 1, Release 1.2.1—RoCE Annex A16, which are incorporated by reference herein).

The RDMA verbs API 215 implements RDMA verbs, the interface to an RDMA enabled network interface controller. The RDMA verbs can be used by user-space applications to invoke RDMA functionality. The RDMA verbs typically provide access to RDMA queuing and memory management resources, as well as underlying network layers.

In the example implementation, the RDMA verbs provided by the RDMA Verbs API 215 are RDMA verbs that are defined in the INIFNIBAND Architecture (IBA) specification. RDMA verbs include the following verbs: Create Queue Pair, Modify Queue Pair, Destroy Queue Pair, Post Send Request, and Register Memory Region.

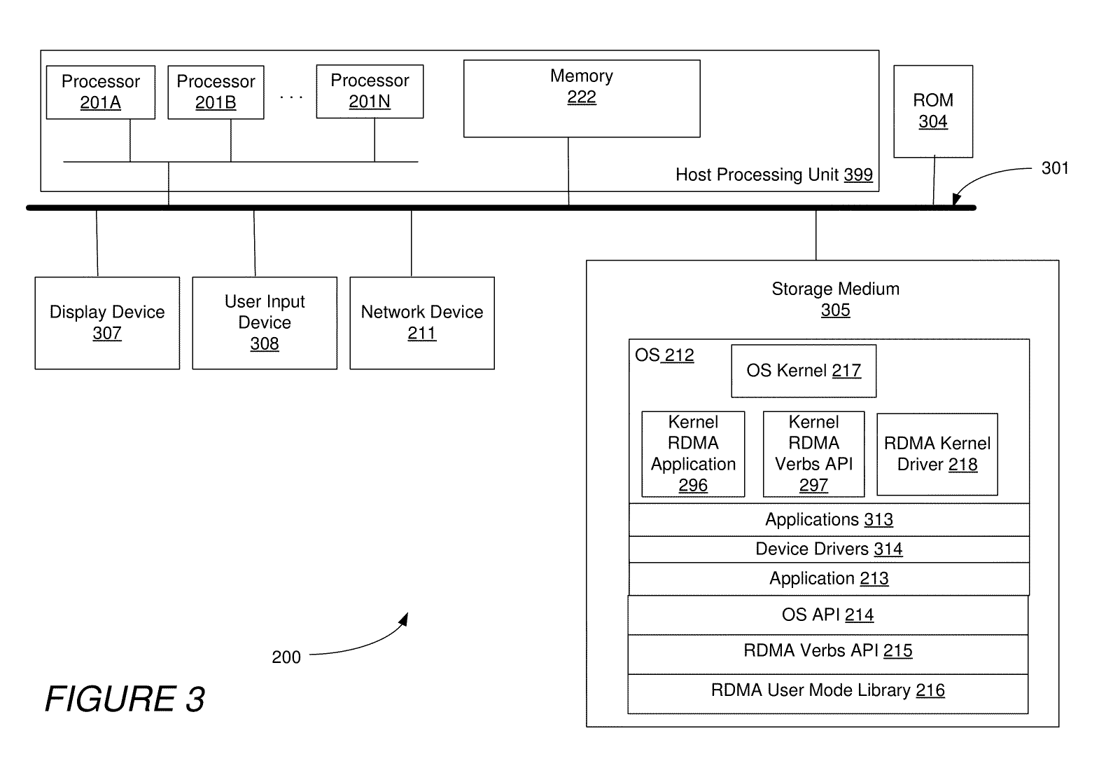

FIG. 3 is an architecture diagram of the RDMA system 200 in accordance with an example embodiment. In the example embodiment, the RDMA system 200 is a server device.

The bus 301 interfaces with the processors 201A-201N, the main memory (e.g., a random access memory (RAM)) 222, a read only memory (ROM) 304, a processor-readable storage medium 305, a display device 307, a user input device 308, and the network device 211 of FIG. 2B.

The processors 201A-201N may take many forms, such as ARM processors, X86 processors, and the like.

In some implementations, the RDMA system 200 includes at least one of a central processing unit (processor) and a multi-processor unit (MPU).

The processors 201A-201N and the main memory 222 form a host processing unit 399. In some embodiments, the host processing unit includes one or more processors communicatively coupled to one or more of a RAM, ROM, and machine-readable storage medium; the one or more processors of the host processing unit receive instructions stored by the one or more of a RAM, ROM, and machine-readable storage medium via a bus; and the one or more processors execute the received instructions. In some embodiments, the host processing unit is an application-specific integrated circuit (ASIC) device. In some embodiments, the host processing unit is a system-on-chip (SOC) device. In some embodiments, the host processing unit includes one or more of the RDMA Kernel Driver, the Kernel RDMA Verbs API, the Kernel RDMA Application, the RDMA Verbs API, and the RDMA User Mode Library.

The network adapter device 211 provides one or more wired or wireless interfaces for exchanging data and commands between the RDMA system 200 and other devices, such as a remote RDMA system. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system 212, application programs 313, and device drivers 314) are loaded into the memory 222 (of the host processing unit 399) from the processor-readable storage medium 305, the ROM 304 or any other storage location. During execution of these software programs, the respective machine-executable instructions are accessed by at least one of processors 201A-201N (of the host processing unit 399) via the bus 301, and then executed by at least one of processors 201A-201N. Data used by the software programs are also stored in the memory 222, and such data is accessed by at least one of processors 201A-201N during execution of the machine-executable instructions of the software programs.

The processor-readable storage medium 305 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 305 includes software programs 313, device drivers 314, and the operating system 212, the application 213, the OS API 214, the RDMA Verbs API 215, and the RDMA user mode library 216 of FIG. 2B. The OS 212 includes the OS kernel 217, the RDMA kernel driver 218, the Kernel RDMA Application 296, and the Kernel RDMA Verbs API 297 of FIG. 2B.

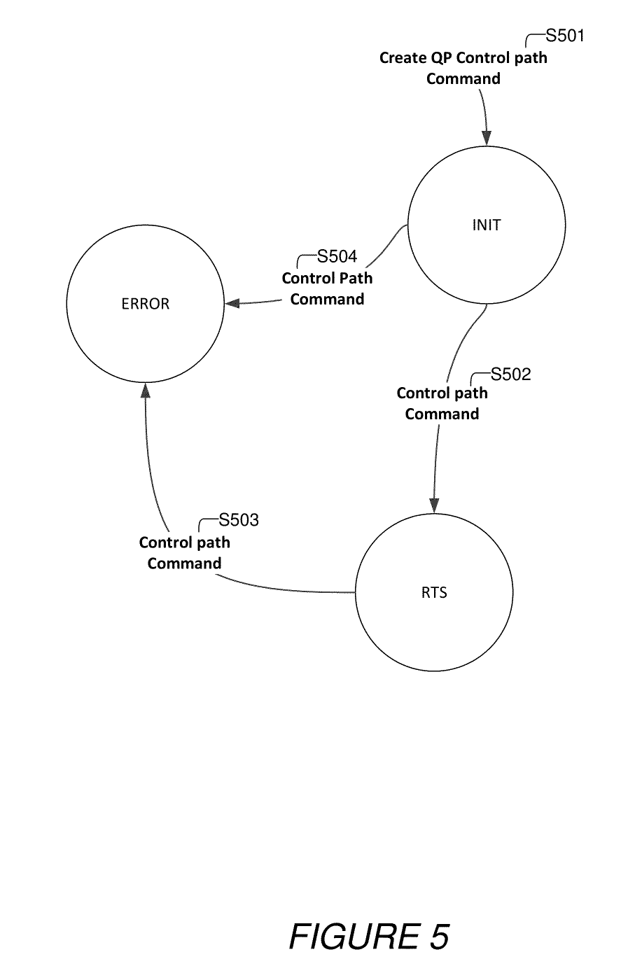

The RDMA kernel driver 218 includes instructions that are executed by the host processing unit 399 to perform the processes described below with respect to FIGS. 5 to 8. In some embodiments, the RDMA user mode library 216 includes instructions that are executed by the host processing unit 399 to perform the processes described below with respect to FIGS. 5 to 8.

More specifically, the RDMA kernel driver 218 includes instructions to control the host processing unit 399 to provide the adapter device 211 with adapter device commands and in-band RDMA Work Request Elements (WQEs).

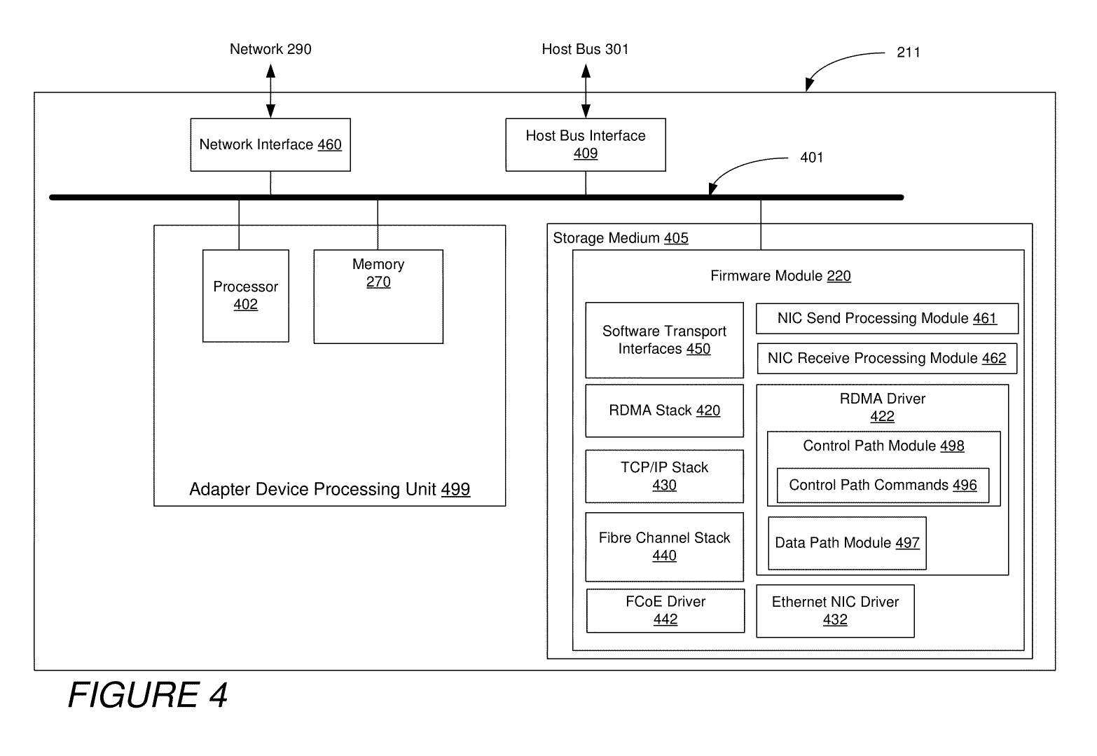

As described below in relation to FIG. 4, the adapter device firmware module 220 includes a control path module 498 that includes instructions to process adapter device commands provided to the adapter device 211 by the host processing unit 399. Adapter device commands are processed by an RDMA control path of the adapter device 211. In some embodiments, the host processing unit 399 can provide adapter device commands to the adapter device 211 regardless of queue pair states of queue pairs of the adapter device 211.

The adapter device firmware module 220 also includes a data path module 497 that includes instructions to process RDMA Work Queue Elements (WQEs) provided by the host processing unit 399 to the adapter device 211 via a queue pair (e.g., one of the queue pairs 256 and 257 of FIG. 2B) of the adapter device 211. The RDMA WQEs include in-band RDMA WQEs generated by execution of instructions of an RDMA driver (e.g., one of the RDMA kernel driver 218 and the RDMA user mode library 216) by the host processing unit 399 and application RDMA WQEs generated by execution of instructions of an application (e.g., one of the application 213 and the kernel RDMA application 296 of FIG. 2B) by the host processing unit 399.

In some embodiments, in-band RDMA WQEs include data that is to be processed by an RDMA data path of the adapter device 211 to effect configuration of the adapter device 211. In some embodiments, the host processing unit 399 can provide in-band WQEs to the adapter device 211 via a queue pair that is in one of the Initialized (INIT) state, the ready to receive (RTR) state and the ready to send (RTS) state. Similarly, the RDMA data path of the adapter device 211 can process in-band RDMA WQEs received via a queue pair that is in one of the Initialized (INIT) state, the ready to receive (RTR) state and the ready to send (RTS) state. In some implementations, the host processing unit 399 cannot provide in-band WQEs to the adapter device 211 via a queue pair that is in a RESET state.

In relation to FIGS. 5 to 7, the kernel driver 218 includes instructions to control the host processing unit 399 to provide an INIT state create queue pair adapter device command to the adapter device 211. The INIT state create queue pair adapter device command is a command instructing the adapter device 211 to create an RDMA queue pair (e.g., one of the queue pairs 256 and 257 of FIG. 2B) in an initialized (INIT) state. In an implementation, the host processing unit 399 provides the INIT state create queue pair adapter device command to the adapter device 211 during processing of an RDMA verb to create an RDMA queue pair (e.g., one of the queue pairs 256 and 257 of FIG. 2B). In such an implementation, the RDMA verb is invoked by an RDMA application (e.g., one of the application 213 and the kernel RDMA application 296 of FIG. 2B).

In relation to FIG. 5, the kernel driver 218 includes instructions to control the host processing unit 399 to provide an RTS state queue pair state transition adapter device command to the adapter device 211. The RTS state queue pair state transition adapter device command is a command instructing the adapter device 211 to transition the RDMA queue pair from the initialized state to a ready to send (RTS) state, and providing RDMA transmit operation information and RDMA receive operation information as command parameters. In an implementation, the host processing unit 399 provides the RTS state queue pair state transition adapter device command to the adapter device 211 during processing of an RDMA verb to modify an RDMA queue pair (e.g., one of the queue pairs 256 and 257 of FIG. 2B). In such an implementation, the RDMA verb is invoked by an RDMA application (e.g., one of the application 213 and the kernel RDMA application 296 of FIG. 2B).

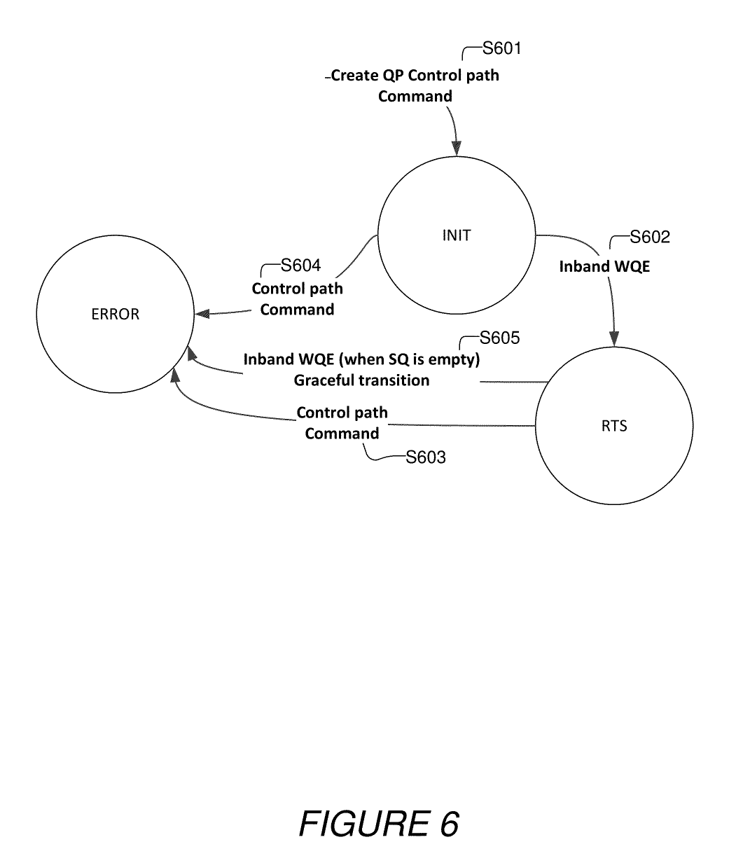

In relation to FIG. 6, the kernel driver 218 includes instructions to control the host processing unit 399 to provide a ready to send (RTS) in-band RDMA WQE to the adapter device 211 via a queue pair (e.g., one of the queue pairs 256 and 257 of FIG. 2B) that has been created in the initialized state. Such an RTS in-band RDMA WQE includes RDMA receive operation information and RDMA transmit operation information to configure the created queue pair for RDMA receive and transmit operations and to transition the RDMA queue pair from the initialized state to the ready to send state.

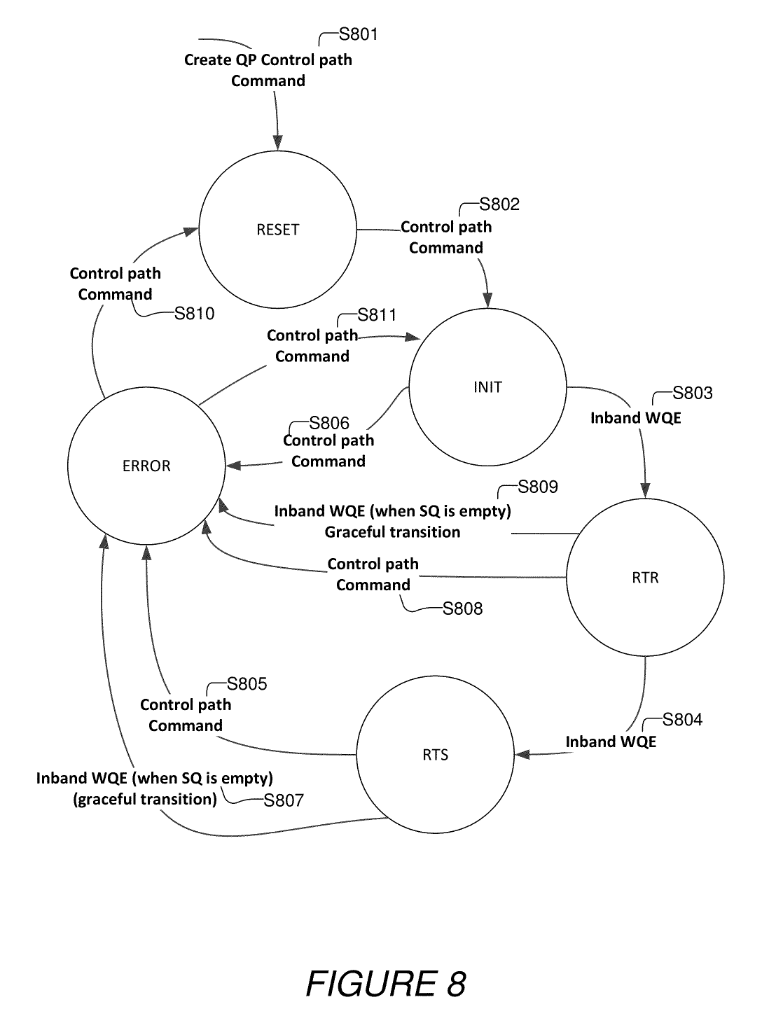

In relation to FIG. 8, the kernel driver 218 includes instructions to control the host processing unit 399 to provide a RESET state create queue pair adapter device command to the adapter device 211. The RESET state create queue pair adapter device command is a command instructing the adapter device 211 to create an RDMA queue pair (e.g., one of the queue pairs 256 and 257 of FIG. 2B) in a RESET state. In an implementation, the host processing unit 399 provides the RESET state create queue pair adapter device command to the adapter device 211 during processing of an RDMA verb to create an RDMA queue pair (e.g., one of the queue pairs 256 and 257 of FIG. 2B). In such an implementation, the RDMA verb is invoked by an RDMA application (e.g., one of the application 213 and the kernel RDMA application 296 of FIG. 2B).

In relation to FIG. 8, the kernel driver 218 includes instructions to control the host processing unit 399 to provide an INIT state queue pair state transition adapter device command to the adapter device 211. The INIT state queue pair state transition adapter device command is a command instructing the adapter device 211 to transition the RDMA queue pair from the RESET state to the INIT state. In an implementation, the host processing unit 399 provides the INIT state queue pair state transition adapter device command to the adapter device 211 during processing of an RDMA verb to modify an RDMA queue pair (e.g., one of the queue pairs 256 and 257 of FIG. 2B). In such an implementation, the RDMA verb is invoked by an RDMA application (e.g., one of the application 213 and the kernel RDMA application 296 of FIG. 2B).

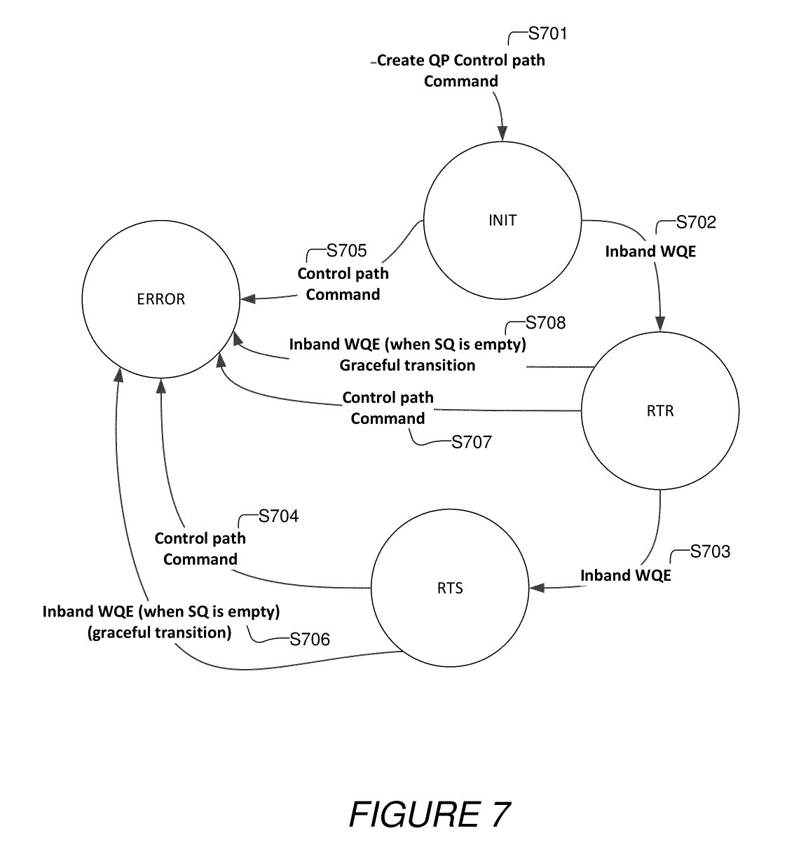

In relation to FIGS. 7 and 8, the kernel driver 218 includes instructions to control the host processing unit 399 to provide a ready to receive (RTR) in-band RDMA WQE to the adapter device 211 via a created queue pair in the initialized state. Such an RTR in-band RDMA WQE includes RDMA receive operation information to configure the created queue pair for RDMA receive operations and to transition the RDMA queue pair from the initialized state to the RTR state. The kernel driver 218 includes instructions to control the host processing unit 399 to provide a ready to send (RTS) in-band RDMA WQE to the adapter device 211 via a queue pair in the RTR state. Such an RTS in-band RDMA WQE includes RDMA transmit operation information to configure the queue pair for RDMA transmit operations and to transition the RDMA queue pair from the RTR state to the RTS state.

In relation to FIG. 8, the kernel driver 218 includes instructions to control the host processing unit 399 to provide at least one of a recycle queue pair state transition adapter device command and a recycle state transition in-band RDMA WQE to the adapter device 211 to control the adapter device 211 to transition the RDMA queue pair from the ERROR state to at least one of the INIT state and a RESET state.

In relation to FIGS. 5 to 8, the kernel driver 218 includes instructions to control the host processing unit 399 to provide at least one of an ERROR queue pair state transition adapter device command and an ERROR state transition in-band RDMA Work Queue Element (WQE) to the adapter device 211 to control the adapter device to transition the RDMA queue pair to an ERROR state.

In some embodiments, the RDMA user mode library 216 includes one or more of the instructions described above as being included in the kernel driver 218.

An architecture diagram of the RDMA network adapter device 211 of the RDMA system 200 is provided in FIG. 4.

In the example embodiment, the RDMA network adapter device 211 is a network communication adapter device that is constructed to be included in a server device. In some embodiments, the RDMA network device is a network communication adapter device that is constructed to be included in one or more of different types of RDMA systems, such as, for example, client devices, network devices, mobile devices, smart appliances, wearable devices, medical devices, storage devices, sensor devices, vehicles, and the like.

The bus 401 interfaces with a processor 402, a random access memory (RAM) 270, a processor-readable storage medium 405, a host bus interface 409 and a network interface 460.

The processor 402 may take many forms, such as, for example, a central processing unit (processor), a multi-processor unit (MPU), an ARM processor, and the like.

The processor 402 and the memory 270 form an adapter device processing unit 499. In some embodiments, the adapter device processing unit includes one or more processors communicatively coupled to one or more of a RAM, ROM, and machine-readable storage medium; the one or more processors of the adapter device processing unit receive instructions stored by the one or more of a RAM, ROM, and machine-readable storage medium via a bus; and the one or more processors execute the received instructions. In some embodiments, the adapter device processing unit is an ASIC (Application-Specific Integrated Circuit). In some embodiments, the adapter device processing unit is a SoC (System-on-Chip). In some embodiments, the adapter device processing unit includes the firmware module 220. In some embodiments, the adapter device processing unit includes the RDMA Driver 422. In some embodiments, the adapter device processing unit includes one or more of the control path module 498 and the data path module 497. In some embodiments, the adapter device processing unit includes the RDMA stack 420. In some embodiments, the adapter device processing unit includes the software transport interfaces 450.

The network interface 460 provides one or more wired or wireless interfaces for exchanging data and commands between the network communication adapter device 211 and other devices, such as, for example, another network communication adapter device. Such wired and wireless interfaces include, for example, a Universal Serial Bus (USB) interface, Bluetooth interface, Wi-Fi interface, Ethernet interface, Near Field Communication (NFC) interface, and the like.

The host bus interface 409 provides one or more wired or wireless interfaces for exchanging data and commands via the host bus 301 of the RDMA system 200. In the example implementation, the host bus interface 409 is a PCIe host bus interface.

Machine-executable instructions in software programs are loaded into the memory 270 (of the adapter device processing unit 499) from the processor-readable storage medium 405, or any other storage location. During execution of these software programs, the respective machine-executable instructions are accessed by the processor 402 (of the adapter device processing unit 499) via the bus 401, and then executed by the processor 402. Data used by the software programs are also stored in the memory 270, and such data is accessed by the processor 402 during execution of the machine-executable instructions of the software programs.

The processor-readable storage medium 405 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 405 includes the firmware module 220.

The firmware module 220 includes instructions to perform the processes described below with respect to FIGS. 5 to 8.

More specifically, the firmware module 220 includes software transport interfaces 450, an RDMA stack 420, an RDMA driver 422, a TCP/IP stack 430, an Ethernet NIC driver 432, a Fibre Channel stack 440, an FCoE (Fibre Channel over Ethernet) driver 442, a NIC send queue processing module 461, and a NIC receive queue processing module 462.

In some implementations, RDMA verbs are implemented in software transport interfaces 450. In the example implementation, the RDMA protocol stack 420 is an INFINIBAND protocol stack. In the example implementation the RDMA stack 420 handles different protocol layers, such as the transport, network, data link and physical layers.

In some embodiments, the RDMA network device 211 is configured with full RDMA offload capability, which means that both the RDMA protocol stack 420 and the RDMA verbs (e.g., included in the software transport interfaces 450) are implemented in the hardware of the RDMA network device 211. In some embodiments, the RDMA network device 211 uses the RDMA protocol stack 420, the RDMA driver 422, and the software transport interfaces 450 to provide RDMA functionality. The RDMA network device 211 uses the Ethernet NIC driver 432 and the corresponding TCP/IP stack 430 to provide Ethernet and TCP/IP functionality. The RDMA network device 211 uses the Fibre Channel over Ethernet (FCoE) driver 442 and the corresponding Fibre Channel stack 440 to provide Fibre Channel over Ethernet functionality.

In operation, the RDMA network device 211 communicates with different protocol stacks through specific protocol drivers. In some embodiments, the RDMA network device 211 communicates by using the RDMA stack 420 in connection with the RDMA driver 422, communicates by using the TCP/IP stack 430 in connection with the Ethernet driver 432, and communicates by using the Fibre Channel (FC) stack 440 in connection with the Fibre Channel over the Ethernet (FCoE) driver 442.

The RDMA driver 422 includes a control path module 498, and a data path module 497.

The control path module 498 includes instructions to process adapter device commands 496 provided to the adapter device 211 by the host processing unit 399. In some implementations, the control path module processes adapter device commands (control path commands) 496 by using control path hardware. In some implementations, the adapter device 211 receives adapter device commands from the host processing unit 399 via the host bus interface 409.

The control path module 498 includes instructions for processing: an INIT state create queue pair adapter device command to create an RDMA queue pair in an initialized (INIT) state; a RESET state create queue pair adapter device command to create an RDMA queue pair in a RESET state; an INIT state queue pair state transition adapter device command to transition the RDMA queue pair from the RESET state to the initialized state; an RTS state queue pair state transition adapter device command to provide RDMA transmit operation information and RDMA receive operation information for the RDMA queue pair from the host processing unit 399 to the adapter device 211 and transition the RDMA queue pair from the initialized state to a ready to send (RTS) state; an RTR state queue pair state transition adapter device command to receive RDMA receive operation information for the RDMA queue pair at the adapter device and transition the RDMA queue pair from the initialized state to a ready to receive (RTR) state; a recycle queue pair state transition adapter device command to transition the RDMA queue pair from an ERROR state the RESET state; a recycle queue pair state transition adapter device command to transition the RDMA queue pair from the ERROR state the INIT state; an ERROR queue pair state transition adapter device command to transition the RDMA queue pair from the INIT state the ERROR state; an ERROR queue pair state transition adapter device command to transition the RDMA queue pair from the RTR state the ERROR state; an ERROR queue pair state transition adapter device command to transition the RDMA queue pair from the RTS state the ERROR state.

The data path module 497 includes instructions to process RDMA Work Queue Elements (WQEs) provided by the host processing unit 399 to the adapter device 211 via a queue pair of the adapter device 211. The RDMA WQEs include in-band RDMA WQEs generated by execution of instructions of an RDMA kernel driver (e.g., one of the RDMA kernel driver 218 and the RDMA user mode library 216) by the host processing unit 399, and application RDMA WQEs generated by execution of instructions of an application (e.g., one of the application 213 and the kernel RDMA application 296 of FIG. 2B) by the host processing unit 399.

In some implementations, the adapter device 211 receives RDMA WQEs from the host processing unit 399 via the host bus interface 409.

In some implementations, the data path module processes RDMA WQEs by using data path hardware. In some implementations, the data path hardware is constructed to provide increased speed and performance via the data path, as opposed to the control path.

FIG. 5 is a state diagram that depicts queue pair (QP) state transition in relation to processing of an RDMA verb to create an RDMA queue pair (e.g., one of the queue pairs 256 and 257 of FIG. 2B), according to an embodiment. The RDMA verb is invoked by an RDMA application (e.g., one of the application 213 and the kernel RDMA application 296 of FIG. 2B). As shown in FIG. 5, the host processing unit 399 processes the RDMA verb to create an RDMA queue pair by providing the INIT state create queue pair adapter device command to the adapter device 211 to create the queue pair in the INIT state, followed by the RTS state queue pair state transition adapter device command to transition the queue pair from the INIT state to the RTS state.

As shown in FIG. 5, a number of state transitions can be reduced, as compared with the processing described above in relation to FIG. 1. In this manner, an establishment time to make a queue pair usable can be reduced.

As described below, the host processing unit 399 executes instructions of the RDMA kernel driver 218 to perform processes S501 to S504 of FIG. 5. In some embodiments, the host processing unit 399 executes instructions of the RDMA user mode library 216 to perform processes S501 to S504 of FIG. 5.

At process S501, an RDMA application (e.g., one of the application 213 and the kernel RDMA application 296 of FIG. 2B) invokes an RDMA verb (e.g., the Create Queue Pair verb) to create an RDMA queue pair. Responsive to the invocation of the RDMA verb, the host processing unit 399 executes instructions of the RDMA kernel driver 218 to provide the INIT state create queue pair adapter device command to the adapter device 211 via the host bus 301 of FIGS. 3 and 4. The INIT state create queue pair adapter device command at the process S501 is the INIT state create queue pair adapter device command to create an RDMA queue pair in an initialized (INIT) state. Responsive to reception of the INIT state create queue pair adapter device command by the adapter device 211, the adapter device processing unit 499 executes instructions of the control path module 498 to process the adapter device command to create the RDMA queue pair in an initialized (INIT) state.

At process S502, the host processing unit 399 executes instructions of the RDMA kernel driver 218 to provide the RTS state queue pair state transition adapter device command to the adapter device 211. The adapter device command at the process S502 is the command to provide RDMA transmit operation information and RDMA receive operation information for the RDMA queue pair to the adapter device 211 and transition the RDMA queue pair from the initialized state to a ready to send (RTS) state. Responsive to reception of the RTS state queue pair state transition adapter device command by the adapter device 211, the adapter device processing unit 499 executes instructions of the control path module 498 to process the adapter device command to transition the RDMA queue pair from the initialized state to a ready to send (RTS) state.

At process S503, an RDMA application (e.g., one of the application 213 and the kernel RDMA application 296 of FIG. 2B) invokes an RDMA verb (e.g., the Destroy Queue Pair verb) to destroy the RDMA queue pair created at the process S501. Responsive to the invocation of the destroy queue pair RDMA verb, the host processing unit 399 executes instructions of the RDMA kernel driver 218 to provide the ERROR queue pair state transition adapter device command to the adapter device 211. The adapter device command at the process S503 is the command to transition the RDMA queue pair from the RTS state the ERROR state. The adapter device processing unit 499 executes instructions of the control path module 498 to process the adapter device command to transition the RDMA queue pair from the RTS state the ERROR state.

At process S504, an RDMA application invokes an RDMA verb (e.g., the Destroy Queue Pair verb) to destroy the RDMA queue pair created at the process S501. Responsive to the invocation of the destroy queue pair RDMA verb, the host processing unit 399 executes instructions of the RDMA kernel driver 218 to provide the ERROR queue pair state transition adapter device command to the adapter device 211. The adapter device command at the process S504 is the command to transition the RDMA queue pair from the INIT state the ERROR state. The adapter device processing unit 499 executes instructions of the control path module 498 to process the adapter device command to transition the RDMA queue pair from the INIT state the ERROR state.

By virtue of transitioning the queue pair to the ERROR state rather than destroying the queue pair in response to the destroy queue pair RDMA verb, the queue pair can be recycled by transitioning the queue pair from the error state to the INIT state in response to a queue pair state transition adapter device command.

FIG. 6 is a state diagram that depicts queue pair (QP) state transition in relation to processing of an RDMA verb to create an RDMA queue pair, according to an embodiment. As shown in FIG. 6, the host processing unit 399 processes the RDMA verb to create an RDMA queue pair by providing an INIT state create queue pair adapter device command to the adapter device 211 to create the queue pair in the INIT state, followed by a ready to send (RTS) in-band RDMA WQE to transition the RDMA queue pair from the initialized state to the ready to send state.

As shown in FIG. 6, a number of state transitions can be reduced, as compared with the processing described above in relation to FIG. 1. In this manner, an establishment time to make a queue pair usable can be reduced. Moreover, providing an in-band RDMA WQE (which is processed by the data path of the adapter device 211) to transition state of the queue pair may provide improved performance as compared to providing an adapter device command which is processed by the control path. For example, the effect of control path bottlenecks on performance can be reduced by bypassing the control path during state transition and using the data path to effect queue pair state transition by processing of in-band RDMA WQEs.

As described below, the host processing unit 399 executes instructions of the RDMA kernel driver 218 to perform processes S601 to S605 of FIG. 6. In some embodiments, the host processing unit 399 executes instructions of the RDMA user mode library 216 to perform processes S601 to S605 of FIG. 6.

At process S601, an RDMA application invokes an RDMA verb (e.g., the Create Queue Pair verb) to create an RDMA queue pair. Responsive to the invocation of the create queue pair RDMA verb, the host processing unit 399 executes instructions of the RDMA kernel driver 218 to provide the INIT state create queue pair adapter device command to the adapter device 211. The INIT state create queue pair adapter device command at the process S601 is the create queue pair adapter device command to create an RDMA queue pair in an initialized (INIT) state. Responsive to reception of the INIT state create queue pair adapter device command by the adapter device 211, the adapter device processing unit 499 executes instructions of the control path module 498 to process the adapter device command to create the RDMA queue pair in an initialized (INIT) state.

At process S602, the host processing unit 399 executes instructions of the RDMA kernel driver 218 to generate and send an RTS in-band WQE to the adapter device 211 via the queue pair created at the process S601. The RTS in-band WQE specifies RDMA transmit operation information and RDMA receive operation information for the RDMA queue pair and includes a request to transition the RDMA queue pair from the initialized state to a ready to send (RTS) state. The adapter device processing unit 499 executes instructions of the data path module 497 to process the RTS in-band WQE to transition the RDMA queue pair from the initialized state to a ready to send (RTS) state.

At process S603, an RDMA application invokes an RDMA verb to destroy the RDMA queue pair created at the process S601, and responsive to the invocation of the destroy queue pair RDMA verb the host processing unit 399 executes instructions of the RDMA kernel driver 218 to determine that the send queue (SQ) (e.g., one of the send queues 271 and 273 of FIG. 2B) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S603 is the command to transition the RDMA queue pair from the RTS state the ERROR state. The adapter device processing unit 499 executes instructions of the control path module 498 to process the adapter device command to transition the RDMA queue pair from the RTS state the ERROR state.

At process S604, an RDMA application invokes an RDMA verb to destroy the RDMA queue pair created at the process S601, and responsive to the invocation of the destroy queue pair RDMA verb the host processing unit 399 executes instructions of the RDMA kernel driver 218 to determine that the send queue (SQ) (e.g., one of the send queues 271 and 273 of FIG. 2B) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S604 is the command to transition the RDMA queue pair from the INIT state the ERROR state. The adapter device processing unit 499 executes instructions of the control path module 498 to process the adapter device command to transition the RDMA queue pair from the INIT state the ERROR state.

At process S605, an RDMA application invokes an RDMA verb to destroy the RDMA queue pair created at the process S601, and responsive to the invocation of the destroy queue pair RDMA verb the host processing unit 399 executes instructions of the RDMA kernel driver 218 to determine that the send queue (SQ) of the queue pair is empty. Having determined that the send queue is empty, the host processing unit 399 executes instructions of the RDMA kernel driver 218 to generate and send an ERROR state transition in-band WQE to the adapter device 211 via the send queue of the queue pair. The ERROR state transition in-band WQE includes a request to transition the RDMA queue pair from the RTS state to the ERROR state. The adapter device processing unit 499 executes instructions of the data path module 497 to process the ERROR state transition in-band WQE to transition the RDMA queue pair from the RTS state to the ERROR state.

By virtue of transitioning the queue pair to the ERROR state rather than destroying the queue pair in response to the destroy queue pair RDMA verb, the queue pair can be recycled by transitioning the queue pair from the error state to the INIT state. In some embodiments, the state of the queue pair is transitioned to the INIT state in response to one of a queue pair state transition adapter device command and an in-band work queue entry (WQE) that includes a request to transition the queue pair to the INIT state.

As shown by FIGS. 4-6, one or more QP state transitions can be avoided to speed state transition to a ready to send and/or a ready to read state to more quickly establish RDMA connections with a network adapter. Alternatively, standard QP state transitions may be followed while a data path module is used to provide acceleration using in-band work queue entry (WQE) processing.

FIG. 7 is a state diagram that depicts queue pair (QP) state transition in relation to processing of an RDMA verb to create an RDMA queue pair, according to an embodiment. As shown in FIG. 7, the host processing unit 399 processes the RDMA verb to create an RDMA queue pair by providing an INIT state create queue pair adapter device command to the adapter device 211 to create the queue pair in the INIT state, followed by a ready to receive (RTR) in-band RDMA WQE to transition the RDMA queue pair from the initialized state to the ready to receive state. Thereafter, the host processing unit 399 provides the adapter device 211 with a ready to send (RTS) in-band RDMA WQE to transition the RDMA queue pair from the ready to receive state to the ready to send state.

As shown in FIG. 7, a number of state transitions can be reduced, as compared with the processing described above in relation to FIG. 1. In this manner, an establishment time to make a queue pair usable can be reduced. Moreover, providing an in-band RDMA WQE (which is processed by the data path of the adapter device 211) to transition state of the queue pair may provide improved performance as compared to providing an adapter device command which is processed by the control path.

As described below, the host processing unit 399 executes instructions of the RDMA kernel driver 218 to perform processes S701 to S708 of FIG. 7. In some embodiments, the host processing unit 399 executes instructions of the RDMA user mode library 216 to perform processes S701 to S708 of FIG. 7.

At process S701, an RDMA application invokes an RDMA verb (e.g., the Create Queue Pair verb) to create an RDMA queue pair. Responsive to the invocation of the create queue pair RDMA verb, the host processing unit 399 executes instructions of the RDMA kernel driver 218 to provide the INIT state create queue pair adapter device command to the adapter device 211. The INIT state create queue pair adapter device command at the process S701 is the create queue pair adapter device command to create an RDMA queue pair in an initialized (INIT) state. Responsive to reception of the INIT state create queue pair adapter device command by the adapter device 211, the adapter device processing unit 499 executes instructions of the control path module 498 to process the adapter device command to create the RDMA queue pair in an initialized (INIT) state.

At process S702, the host processing unit 399 executes instructions of the RDMA kernel driver 218 to generate and send an RTR in-band WQE to the adapter device 211 via the queue pair created at the process S701. The RTR in-band WQE specifies RDMA receive operation information for the RDMA queue pair and includes a request to transition the RDMA queue pair from the initialized state to a ready to receive (RTR) state. The adapter device processing unit 499 executes instructions of the data path module 497 to process the RTR in-band WQE to transition the RDMA queue pair from the initialized state to a ready to receive (RTR) state.

At process S703, the host processing unit 399 executes instructions of the RDMA kernel driver 218 to generate and send an RTS in-band WQE to the adapter device 211 via the queue pair created at the process S701. The RTS in-band WQE specifies RDMA transmit operation information for the RDMA queue pair and includes a request to transition the RDMA queue pair from the RTR state to a ready to send (RTS) state. The adapter device processing unit 499 executes instructions of the data path module 497 to process the RTS in-band WQE to transition the RDMA queue pair from the RTR state to a ready to send (RTS) state.

At process S704, an RDMA application invokes an RDMA verb to destroy the RDMA queue pair created at the process S701, and responsive to the invocation of the destroy queue pair RDMA verb the host processing unit 399 executes instructions of the RDMA kernel driver 218 to determine that the send queue (SQ) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S704 is the command to transition the RDMA queue pair from the RTS state the ERROR state. The adapter device processing unit 499 executes instructions of the control path module 498 to process the adapter device command to transition the RDMA queue pair from the RTS state the ERROR state.

At process S705, an RDMA application invokes an RDMA verb to destroy the RDMA queue pair created at the process S701, and responsive to the invocation of the destroy queue pair RDMA verb the host processing unit 399 executes instructions of the RDMA kernel driver 218 to determine that the send queue (SQ) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S705 is the command to transition the RDMA queue pair from the INIT state the ERROR state. The adapter device processing unit 499 executes instructions of the control path module 498 to process the adapter device command to transition the RDMA queue pair from the INIT state the ERROR state.

At process S706, an RDMA application invokes an RDMA verb to destroy the RDMA queue pair created at the process S701, and responsive to the invocation of the destroy queue pair RDMA verb the host processing unit 399 executes instructions of the RDMA kernel driver 218 to determine that the send queue (SQ) of the queue pair is empty. Having determined that the send queue is empty, the host processing unit 399 executes instructions of the RDMA kernel driver 218 to generate and send an ERROR state transition in-band WQE to the adapter device 211 via the send queue of the queue pair. The ERROR state transition in-band WQE includes a request to transition the RDMA queue pair from the RTS state to the ERROR state. The adapter device processing unit 499 executes instructions of the data path module 497 to process the ERROR state transition in-band WQE to transition the RDMA queue pair from the RTS state to the ERROR state.

At process S707, an RDMA application invokes an RDMA verb to destroy the RDMA queue pair created at the process S701, and responsive to the invocation of the destroy queue pair RDMA verb the host processing unit 399 executes instructions of the RDMA kernel driver 218 to determine that the send queue (SQ) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S707 is the command to transition the RDMA queue pair from the RTR state the ERROR state. The adapter device processing unit 499 executes instructions of the control path module 498 to process the adapter device command to transition the RDMA queue pair from the RTR state the ERROR state.

At process S708, an RDMA application invokes an RDMA verb to destroy the RDMA queue pair created at the process S701, and responsive to the invocation of the destroy queue pair RDMA verb the host processing unit 399 executes instructions of the RDMA kernel driver 218 to determine that the send queue (SQ) of the queue pair is empty. Having determined that the send queue is empty, the host processing unit 399 executes instructions of the RDMA kernel driver 218 to generate and send an ERROR state transition in-band WQE to the adapter device 211 via the send queue of the queue pair. The ERROR state transition in-band WQE includes a request to transition the RDMA queue pair from the RTR state to the ERROR state. The adapter device processing unit 499 executes instructions of the data path module 497 to process the ERROR state transition in-band WQE to transition the RDMA queue pair from the RTR state to the ERROR state.

By virtue of transitioning the queue pair to the ERROR state rather than destroying the queue pair in response to the destroy queue pair RDMA verb, the queue pair can be recycled by transitioning the queue pair from the error state to the INIT state. In some embodiments, the state of the queue pair is transitioned to the INIT state in response to one of a queue pair state transition adapter device command and an in-band WQE that includes a request to transition the queue pair to the INIT state.

FIG. 8 is a state diagram that depicts queue pair (QP) state transition in relation to processing of an RDMA verb to create an RDMA queue pair, according to an embodiment. As shown in FIG. 8, the host processing unit 399 processes the RDMA verb to create an RDMA queue pair by providing a RESET state create queue pair adapter device command to the adapter device 211 to create the queue pair in the RESET state, followed by an INIT state queue pair state transition adapter device command to transition the RDMA queue pair from the RESET state to the INIT state. After transitioning the queue pair to the INIT state, the host processing unit 399 provides the adapter device 211 with a ready to receive (RTR) in-band RDMA WQE to transition the RDMA queue pair from the initialized state to the ready to receive state, followed by a ready to send (RTS) in-band RDMA WQE to transition the RDMA queue pair from the ready to receive state to the ready to send state.

As shown in FIG. 8, the host processing unit 399 provides in-band RDMA WQEs to the adapter device 211, rather than adapter device commands, to transition the state of the queue pair from the INIT state to RTR and RTS states (as compared with the processing of FIG. 1). In this manner, performance can be improved, as compared to providing an adapter device command which is processed by the control path and whose processing can be impacted by, for example, control path bottlenecks.

As described below, the host processing unit 399 executes instructions of the RDMA kernel driver 218 to perform processes S801 to S811 of FIG. 8. In some embodiments, the host processing unit 399 executes instructions of the RDMA user mode library 216 to perform processes S801 to S811 of FIG. 8.

At process S801, an RDMA application invokes an RDMA verb (e.g., the Create Queue Pair verb) to create an RDMA queue pair. Responsive to the invocation of the create queue pair RDMA verb, the host processing unit 399 executes instructions of the RDMA kernel driver 218 to provide the RESET state create queue pair adapter device command to the adapter device 211. The RESET state create queue pair adapter device command at the process S801 is the create queue pair adapter device command to create an RDMA queue pair in an RESET state. Responsive to reception of the RESET state create queue pair adapter device command by the adapter device 211, the adapter device processing unit 499 executes instructions of the control path module 498 to process the adapter device command to create the RDMA queue pair in an RESET state.

At process S802, the host processing unit 399 executes instructions of the RDMA kernel driver 218 to provide the INIT state queue pair state transition adapter device command to the adapter device 211. The adapter device command at the process S802 is the command to transition the RDMA queue pair from the RESET state to the initialized (INIT) state. Responsive to reception of the INIT state queue pair state transition adapter device command by the adapter device 211, the adapter device processing unit 499 executes instructions of the control path module 498 to process the adapter device command to transition the RDMA queue pair from the RESET state to the INIT state.

At process S803, the host processing unit 399 executes instructions of the RDMA kernel driver 218 to generate and send an RTR in-band WQE to the adapter device 211 via the queue pair created at the process S801. The RTR in-band WQE specifies RDMA receive operation information for the RDMA queue pair and includes a request to transition the RDMA queue pair from the initialized state to a ready to receive (RTR) state. The adapter device processing unit 499 executes instructions of the data path module 497 to process the RTR in-band WQE to transition the RDMA queue pair from the initialized state to a ready to receive (RTR) state.

At process S804, the host processing unit 399 executes instructions of the RDMA kernel driver 218 to generate and send an RTS in-band WQE to the adapter device 211 via the queue pair created at the process S801. The RTS in-band WQE specifies RDMA transmit operation information for the RDMA queue pair and includes a request to transition the RDMA queue pair from the RTR state to a ready to send (RTS) state. The adapter device processing unit 499 executes instructions of the data path module 497 to process the RTS in-band WQE to transition the RDMA queue pair from the RTR state to a ready to send (RTS) state.

At process S805, an RDMA application invokes an RDMA verb to destroy the RDMA queue pair created at the process S801, and responsive to the invocation of the destroy queue pair RDMA verb the host processing unit 399 executes instructions of the RDMA kernel driver 218 to determine that the send queue (SQ) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S805 is the command to transition the RDMA queue pair from the RTS state the ERROR state. The adapter device processing unit 499 executes instructions of the control path module 498 to process the adapter device command to transition the RDMA queue pair from the RTS state the ERROR state.

At process S806, an RDMA application invokes an RDMA verb to destroy the RDMA queue pair created at the process S801, and responsive to the invocation of the destroy queue pair RDMA verb the host processing unit 399 executes instructions of the RDMA kernel driver 218 to determine that the send queue (SQ) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S806 is the command to transition the RDMA queue pair from the INIT state the ERROR state. The adapter device processing unit 499 executes instructions of the control path module 498 to process the adapter device command to transition the RDMA queue pair from the INIT state the ERROR state.

At process S807, an RDMA application invokes an RDMA verb to destroy the RDMA queue pair created at the process S801, and responsive to the invocation of the destroy queue pair RDMA verb the host processing unit 399 executes instructions of the RDMA kernel driver 218 to determine that the send queue (SQ) of the queue pair is empty. Having determined that the send queue is empty, the host processing unit 399 executes instructions of the RDMA kernel driver 218 to generate and send an ERROR state transition in-band WQE to the adapter device 211 via the send queue of the queue pair. The ERROR state transition in-band WQE includes a request to transition the RDMA queue pair from the RTS state to the ERROR state. The adapter device processing unit 499 executes instructions of the data path module 497 to process the ERROR state transition in-band WQE to transition the RDMA queue pair from the RTS state to the ERROR state.

At process S808, an RDMA application invokes an RDMA verb to destroy the RDMA queue pair created at the process S801, and responsive to the invocation of the destroy queue pair RDMA verb the host processing unit 399 executes instructions of the RDMA kernel driver 218 to determine that the send queue (SQ) of the queue pair is not empty. Having determined that the send queue is not empty, the host processing unit 399 executes instructions of the RDMA kernel driver 218 to provide the ERROR queue pair state transition adapter device command to the adapter device 211. The adapter device command at the process S808 is the command to transition the RDMA queue pair from the RTR state the ERROR state. The adapter device processing unit 499 executes instructions of the control path module 498 to process the adapter device command to transition the RDMA queue pair from the RTR state the ERROR state.

At process S809, an RDMA application invokes an RDMA verb to destroy the RDMA queue pair created at the process S801, and responsive to the invocation of the destroy queue pair RDMA verb the host processing unit 399 executes instructions of the RDMA kernel driver 218 to determine that the send queue (SQ) of the queue pair is empty. Having determined that the send queue is empty, the host processing unit 399 executes instructions of the RDMA kernel driver 218 to generate and send an ERROR state transition in-band WQE to the adapter device 211 via the send queue of the queue pair. The ERROR state transition in-band WQE includes a request to transition the RDMA queue pair from the RTR state to the ERROR state. The adapter device processing unit 499 executes instructions of the data path module 497 to process the ERROR state transition in-band WQE to transition the RDMA queue pair from the RTR state to the ERROR state.

At process S810, the host processing unit 399 executes instructions of the RDMA kernel driver 218 to provide a recycle queue pair state transition adapter device command to the adapter device 211. The adapter device command at the process S810 is the command to transition the RDMA queue pair from the ERROR state the RESET state. The adapter device processing unit 499 executes instructions of the control path module 498 to process the adapter device command to transition the RDMA queue pair from the ERROR state the RESET state. In some embodiments, as an alternative to providing a queue pair state transition adapter device command to transition the RDMA queue pair from the ERROR state the RESET state, the host processing unit 399 can execute instructions of the RDMA kernel driver 218 to generate and send an in-band WQE to the adapter device 211 that includes a request to transition the RDMA queue pair from the ERROR state the RESET state.

At process S811, the host processing unit 399 executes instructions of the RDMA kernel driver 218 to provide a recycle queue pair state transition adapter device command to the adapter device 211. The adapter device command at the process S811 is the command to transition the RDMA queue pair from the ERROR state the INIT state. The adapter device processing unit 499 executes instructions of the control path module 498 to process the adapter device command to transition the RDMA queue pair from the ERROR state the INIT state. In some embodiments, as an alternative to providing a queue pair state transition adapter device command to transition the RDMA queue pair from the ERROR state the INIT state, the host processing unit 399 can execute instructions of the RDMA kernel driver 218 to generate and send an in-band WQE to the adapter device 211 that includes a request to transition the RDMA queue pair from the ERROR state the INIT state.

By virtue of transitioning the queue pair to the ERROR state rather than destroying the queue pair in response to the destroy queue pair RDMA verb, the queue pair can be recycled by transitioning the queue pair from the error state to either the INIT state or the RESET state. In some embodiments, the state of the queue pair is transitioned to either the INIT state or the RESET state in response to one of a queue pair state transition adapter device command and an in-band WQE that includes a request to transition the queue pair to either the INIT state or the RESET state.

In some embodiments, recycling of queue pairs can be performed to provide graceful queue shutdown.

In the processes described above with respect to FIGS. 5 to 8, the kernel driver 218 initially configures the queue pair's send queue (SQ) completion queue (e.g., the completion queue 275 of FIG. 2) as the control path command queue's completion queue (CQ) ID. By virtue of this arrangement, the data path module 497 of FIG. 4 may be agnostic of the CQ IDs. In some embodiments, the CQ ID for in-band WQE completions can be provided in the in-band WQE. In some embodiments, the data path module (e.g., the data path module 497 of FIG. 4) determines a CQ ID for in-band WQE's based on configuration information of the adapter device 211 (e.g., to generate implicitly onto the control path command queue's CQ).

As described above, by virtue of using in-band WQE's that are provided via the data path, an impact of control path bottlenecks can be reduced.

While certain exemplary embodiments have been described and shown in the accompanying drawings, it is to be understood that such embodiments are merely illustrative of and not restrictive, and that the embodiments not be limited to the specific constructions and arrangements shown and described, since various other modifications may occur to those ordinarily skilled in the art.

When implemented in software, the elements of the embodiments are essentially the code segments to perform the necessary tasks. The program or code segments can be stored in a processor readable medium or transmitted by a computer data signal embodied in a carrier wave over a transmission medium or communication link. The “processor readable medium” may include any medium that can store information. Examples of the processor readable medium include an electronic circuit, a semiconductor memory device, a read only memory (ROM), a flash memory, an erasable programmable read only memory (EPROM), a floppy diskette, a CD-ROM, an optical disk, a hard disk, etc. The computer data signal may include any signal that can propagate over a transmission medium such as electronic network channels, optical fibers, air, electromagnetic, RF links, etc. The code segments may be downloaded via computer networks such as the Internet, Intranet, etc.

### CONCLUSION

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed embodiments are limited only by patented claims that follow below.

1. A remote direct memory access (RDMA) network communication adapter device that includes:
a storage medium constructed to store an adapter device firmware module that includes a control path module that includes instructions to process adapter device commands provided to the adapter device by a host processing unit in communication with the adapter device via a host bus, the control path module including instructions to process an initialization command to create an RDMA queue pair in an initialized (INIT) state, and
an adapter device processing unit that includes at least one adapter device processor constructed to read instructions of the adapter device firmware module from at least one memory and to execute the instructions of the firmware module by using the at least one adapter device processor, the instructions when executed by the at least one adapter device processor perform processes including:
responsive to reception of the initialization command provided by the host processing unit and received by the adapter device, controlling the adapter device to process the initialization command to create an RDMA queue pair in an initialized (INIT) state such that a reset state is skipped.

2. The adapter device of claim 1,
wherein the initialization command is an INIT state create queue pair adapter device command.

3. The adapter device of claim 2,
wherein the control path module includes instructions to process an RTS state queue pair state transition adapter device command to provide RDMA transmit operation information and RDMA receive operation information for the RDMA queue pair from the host processing unit to the adapter device and transition the RDMA queue pair from the initialized state to a ready to send (RTS) state, and
wherein the firmware module instructions when executed by the at least one adapter device processor further perform processes including:
responsive to reception of the RTS state queue pair state transition adapter device command provided by the host processing unit and received by the adapter device, the RTS state queue pair state transition adapter device command providing RDMA transmit operation information and RDMA receive operation information, controlling the adapter device to process the RTS state queue pair state transition adapter device command to transition the RDMA queue pair from the initialized state to the ready to send (RTS) state such that a ready to receive (RTR) state is skipped.

4. The adapter device of claim 2,
wherein adapter device firmware module includes a data path module that includes instructions to process RDMA Work Queue Elements (WQEs) provided by the host processing unit to the adapter device via a queue pair of the adapter device, the RDMA WQEs including in-band RDMA WQEs generated by execution of instructions of an RDMA driver by the host processing unit and application RDMA WQEs generated by execution of instructions of an application by the host processing unit, and
wherein the firmware module instructions when executed by the at least one adapter device processor further perform processes including:
controlling the adapter device processing unit to process a ready to send (RTS) in-band RDMA WQE received from the host processing unit via the created queue pair in the initialized state, the RTS in-band RDMA WQE including RDMA receive operation information and RDMA transmit operation information to configure the created queue pair for RDMA receive and transmit operations and to transition the RDMA queue pair from the initialized state to the ready to send state.

5. The adapter device of claim 2,
wherein adapter device firmware module includes a data path module that includes instructions to process RDMA Work Queue Elements (WQEs) provided by the host processing unit to the adapter device via a queue pair of the adapter device, the RDMA WQEs including in-band RDMA WQEs generated by execution of instructions of an RDMA driver by the host processing unit and application RDMA WQEs generated by execution of instructions of an application by the host processing unit, and
wherein the firmware module instructions when executed by the at least one adapter device processor further perform processes including:
controlling the adapter device processing unit to process a ready to receive (RTR) in-band RDMA WQE received from the host processing unit via the created queue pair in the initialized state, the RTR in-band RDMA WQE including RDMA receive operation information to configure the created queue pair for RDMA receive operations and to transition the RDMA queue pair from the initialized state to the RTR state, and
controlling the adapter device processing unit to process a ready to send (RTS) in-band RDMA WQE received from the host processing unit via the created queue pair in the RTR state, the RTS in-band RDMA WQE including RDMA transmit operation information to configure the created queue pair for RDMA transmit operations and to transition the RDMA queue pair from the RTR state to the RTS state.

6. The adapter device of claim 2,
wherein the firmware module instructions when executed by the at least one adapter device processor further perform processes including:
responsive to reception of at least one of an ERROR queue pair state transition adapter device command and an ERROR state transition in-band RDMA WQE provided by the host processing unit and received by the adapter device, controlling the adapter device to transition the RDMA queue pair to an ERROR state.

7. The adapter device of claim 6,
wherein the firmware module instructions when executed by the at least one adapter device processor further perform processes including:
responsive to reception of at least one of recycle queue pair state transition adapter device command and a recycle state transition in-band RDMA WQE provided by the host processing unit and received by the adapter device, controlling the adapter device to transition the RDMA queue pair from the ERROR state to at least one of the INIT state and a RESET state.

8. A remote direct memory access (RDMA) network communication adapter device that includes:
a storage medium constructed to store an adapter device firmware module that includes a control path module that includes instructions to process adapter device commands provided to the adapter device by a host processing unit in communication with the adapter device via a host bus and a data path module that includes instructions to process RDMA Work Queue Elements (WQEs) provided by the host processing unit to the adapter device via a queue pair of the adapter device, the RDMA WQEs including in-band RDMA WQEs generated by execution of instructions of an RDMA driver by the host processing unit and application RDMA WQEs generated by execution of instructions of an application by the host processing unit,
wherein the control path module further includes
instructions to process an initialization command to create an RDMA queue pair in an initialized (INIT) state,
instructions to process a RESET state create queue pair adapter device command to create an RDMA queue pair in a RESET state, and
instructions to process an INIT state queue pair state transition adapter device command to transition the RDMA queue pair from the RESET state to the INIT state;
and
an adapter device processing unit that includes at least one adapter device processor constructed to read instructions of the adapter device firmware module from at least one memory and to execute the instructions of the firmware module by using the at least one adapter device processor, the instructions when executed by the at least one adapter device processor perform processes including:
responsive to reception of the initialization command provided by the host processing unit and received by the adapter device, controlling the adapter device to process the initialization command to create an RDMA queue pair in an initialized (INIT) state;
responsive to reception of the RESET state create queue pair adapter device command provided by the host processing unit and received by the adapter device, controlling the adapter device to process the RESET state create queue pair adapter device command to create an RDMA queue pair in the RESET state;
responsive to reception of the INIT state queue pair state transition adapter device command provided by the host processing unit and received by the adapter device, controlling the adapter device to process the INIT state queue pair state transition adapter device command to transition the RDMA queue pair from the RESET state to the INIT state;
controlling the adapter device processing unit to process a ready to receive (RTR) in-band RDMA WQE received from the host processing unit via the created queue pair in the INIT state, the RTR in-band RDMA WQE including RDMA receive operation information to configure the created queue pair for RDMA receive operations and to transition the RDMA queue pair from the INIT state to the RTR state, and
controlling the adapter device processing unit to process a ready to send (RTS) in-band RDMA WQE received from the host processing unit via the created queue pair in the RTR state, the RTS in-band RDMA WQE including RDMA transmit operation information to configure the created queue pair for RDMA transmit operations and to transition the RDMA queue pair from the RTR state to the RTS state.

9. A method of controlling an apparatus that includes a remote direct memory access (RDMA) network communication adapter device, the method comprising:
responsive to reception of an initialization command provided by a host processing unit and received by the adapter device, controlling the adapter device to process the initialization command to create an RDMA queue pair in an initialized (INIT) state,
wherein the adapter device includes:
a storage medium constructed to store an adapter device firmware module that includes a control path module that includes instructions to process adapter device commands provided to the adapter device by the host processing unit, the control path module including instructions to process the initialization command to create an RDMA queue pair in the initialized (INIT) state such that a reset state is skipped, and
an adapter device processing unit that includes at least one adapter device processor constructed to read instructions of the adapter device firmware module from at least one memory and to execute the instructions of the firmware module by using the at least one adapter device processor, and
wherein the host processing unit is in communication with the adapter device via a bus.

10. The method of claim 9,
wherein the initialization command is an INIT state create queue pair adapter device command.

11. The method of claim 10,
wherein the control path module includes instructions to process an RTS state queue pair state transition adapter device command to provide RDMA transmit operation information and RDMA receive operation information for the RDMA queue pair from the host processing unit to the adapter device and transition the RDMA queue pair from the initialized state to a ready to send (RTS) state, and
the method further comprising:
controlling the host processing unit to provide the INIT state create queue pair adapter device command to the adapter device;
controlling the host processing unit to provide the RTS state queue pair state transition adapter device command to the adapter device, the RTS state queue pair state transition adapter device command providing RDMA transmit operation information and RDMA receive operation information;
responsive to reception of the RTS state queue pair state transition adapter device command provided by the host processing unit and received by the adapter device, controlling the adapter device to process the RTS state queue pair state transition adapter device command to transition the RDMA queue pair from the initialized state to the ready to send (RTS) state such that a ready to receive (RTR) state is skipped.

12. The method of claim 10,
wherein adapter device firmware module includes a data path module that includes instructions to process RDMA Work Queue Elements (WQEs) provided by the host processing unit to the adapter device via a queue pair of the adapter device, the RDMA WQEs including in-band RDMA WQEs generated by execution of instructions of an RDMA driver by the host processing unit and application RDMA WQEs generated by execution of instructions of an application by the host processing unit, and
the method further comprising:
controlling the host processing unit to provide the INIT state create queue pair adapter device command to the adapter device;
controlling the host processing unit to provide a ready to send (RTS) in-band RDMA WQE to the adapter device via the created queue pair in the initialized state, the RTS in-band RDMA WQE including RDMA receive operation information and RDMA transmit operation information to configure the created queue pair for RDMA receive and transmit operations and to transition the RDMA queue pair from the initialized state to the ready to send state;
controlling the adapter device processing unit to process the ready to send (RTS) in-band RDMA WQE received from the host processing unit to transition the RDMA queue pair from the initialized state to the ready to send state.

13. The method of claim 10,
wherein adapter device firmware module includes a data path module that includes instructions to process RDMA Work Queue Elements (WQEs) provided by the host processing unit to the adapter device via a queue pair of the adapter device, the RDMA WQEs including in-band RDMA WQEs generated by execution of instructions of an RDMA driver by the host processing unit and application RDMA WQEs generated by execution of instructions of an application by the host processing unit, and
the method further comprising:
controlling the host processing unit to provide the INIT state create queue pair adapter device command to the adapter device;
controlling the host processing unit to provide a ready to receive (RTR) in-band RDMA WQE to the adapter device via the created queue pair in the initialized state, the RTR in-band RDMA WQE including RDMA receive operation information to configure the created queue pair for RDMA receive operations and to transition the RDMA queue pair from the initialized state to the RTR state;
controlling the adapter device processing unit to process the ready to receive (RTR) in-band RDMA WQE received from the host processing unit to transition the RDMA queue pair from the initialized state to the RTR state;
controlling the host processing unit to provide a ready to send (RTS) in-band RDMA WQE to the adapter device via the created queue pair in the RTR state, the RTS in-band RDMA WQE including RDMA transmit operation information to configure the created queue pair for RDMA transmit operations and to transition the RDMA queue pair from the RTR state to the RTS state;
controlling the adapter device processing unit to process the ready to send (RTS) in-band RDMA WQE received from the host processing unit to transition the RDMA queue pair from the RTR state to the RTS state.

14. The method of claim 10,
wherein the control path module includes:
instructions to process a RESET state create queue pair adapter device command to create an RDMA queue pair in a RESET state
instructions to process an INIT state queue pair state transition adapter device command to transition the RDMA queue pair from the RESET state to the INIT state, and
wherein adapter device firmware module includes a data path module that includes instructions to process RDMA Work Queue Elements (WQEs) provided by the host processing unit to the adapter device via a queue pair of the adapter device, the RDMA WQEs including in-band RDMA WQEs generated by execution of instructions of an RDMA driver by the host processing unit and application RDMA WQEs generated by execution of instructions of an application by the host processing unit
the method further comprising:
controlling the host processing unit to provide the RESET state create queue pair adapter device command to the adapter device;
responsive to reception of the RESET state create queue pair adapter device command provided by the host processing unit and received by the adapter device, controlling the adapter device to process the RESET state create queue pair adapter device command to create an RDMA queue pair in the RESET state;
controlling the host processing unit to provide the INIT state queue pair state transition adapter device command to the adapter device;
responsive to reception of the INIT state queue pair state transition adapter device command provided by the host processing unit and received by the adapter device, controlling the adapter device to process the INIT state queue pair state transition adapter device command to transition the RDMA queue pair from the RESET state to the INIT state;
controlling the host processing unit to provide a ready to receive (RTR) in-band RDMA WQE to the adapter device via the created queue pair in the INIT state, the RTR in-band RDMA WQE including RDMA receive operation information to configure the created queue pair for RDMA receive operations and to transition the RDMA queue pair from the initialized state to the RTR state;
controlling the adapter device processing unit to process the ready to receive (RTR) in-band RDMA WQE received from the host processing unit to transition the RDMA queue pair from the initialized state to the RTR state;
controlling the host processing unit to provide a ready to send (RTS) in-band RDMA WQE to the adapter device via the created queue pair in the RTR state, the RTS in-band RDMA WQE including RDMA transmit operation information to configure the created queue pair for RDMA transmit operations and to transition the RDMA queue pair from the RTR state to the RTS state;
controlling the adapter device processing unit to process the ready to send (RTS) in-band RDMA WQE received from the host processing unit to transition the RDMA queue pair from the RTR state to the RTS state.

15. The method of claim 10, the method further comprising:
responsive to reception of at least one of an ERROR queue pair state transition adapter device command and an ERROR state transition in-band RDMA WQE provided by the host processing unit and received by the adapter device, controlling the adapter device to transition the RDMA queue pair to an ERROR state.

16. The method of claim 15, the method further comprising:
responsive to reception of at least one of a recycle queue pair state transition adapter device command and a recycle state transition in-band RDMA WQE provided by the host processing unit and received by the adapter device, controlling the adapter device to transition the RDMA queue pair from the ERROR state to at least one of the INIT state and a RESET state.

17-22. (canceled)

23. The adapter device of claim 8, wherein
a completion queue (CQ) identifier (ID) for a WQE completion for an in-band RDMA WQE is provided in the in-band WQE.

24. The adapter device of claim 8, wherein
the data path module determines a completion queue (CQ) identifier (ID) for a WQE completion for an in-band RDMA WQE based on configuration information of the adapter device.
